(19) United States
(12) Patent Application Publication
(10) Pub. No.: US 2026/0319878 A1
(43) Pub. Date: Oct. 15, 2026

(54) SYSTEM AND METHOD FOR CENTRALIZED RESOURCE INFORMATION MANAGEMENT WITH STANDARD COMPLIANT LOOKUP

(71) Applicant: TOYOTA JIDOSHA KABUSHIKI KAISHA, Toyota-shi (JP)

(72) Inventors: Caleb MCGARY, Tokyo (JP); Jean-Francois BASTIEN, Tokyo (JP)

(73) Assignee: TOYOTA JIDOSHA KABUSHIKI KAISHA, Toyota-shi (JP)

(21) Appl. No.: 19/179,426

(22) Filed: Apr. 15, 2025

(51) Int. Cl. G06F 11/07; G06F 9/455

(52) U.S. Cl. CPC G06F 11/079; G06F 9/45558; G06F 11/0739; G06F 2009/45579

(57) ABSTRACT

Provided are a method, system, and device for managing resources in a vehicle. The system may include a primary electronic control unit (ECU) comprising a virtual machine (VM) and a type one hypervisor; and a plurality of secondary ECUs communicatively coupled to the primary ECU, each of the plurality of secondary ECUs comprises a physical resource; wherein the type one hypervisor is configured to: receive, from at least one ECU of the plurality of secondary ECU's, sensor data associated with a physical resource of the at least one ECU, wherein the physical resource is associated with a tag stored in a safety standard compliant database; and detect, based on the sensor data, that a fault has occurred; and determine, based on detecting the fault has occurred and the tag, whether an intervention action should be executed by the vehicle.

Example embodiments of the present disclosure relate to centralized resource information management in a vehicle.

### BACKGROUND

Modern vehicles are capable of performing a wide range of complex functions, such as generating telemetry data, transmitting and receiving data via the Internet, providing driving assistance, and the like. Such functions are achieved via various subsystems and electronic control units (ECUs) in the vehicle.

In the related art, an ECU may be associated with and be responsible for a particular functionality of a vehicle, and may be in the form of a system on chip (SoC) which has its own physical/hardware components, such as memory, processing units, peripherals, interfaces, and the like, separated from other ECUs. Said physical/hardware components provide resources (e.g., memory, processing power, etc.) for performing operations associated with the particular functionality of the particular ECU.

In the related art, safety compliance standards may need to be implemented for vehicles. For example, Automotive Safety Level Determination (ASLD) is a standard which describes levels of risk/hazard associated with a certain vehicle part/action. In this regard, ECU's which are responsible for controlling safety-critical parts of a vehicle (for example, brakes, airbags) may need to be able to respond quickly to faults and perform predictive maintenance. However, it may be difficult to ensure that the ECU is compliant with the safety standard.

Accordingly, there is a need for a more centralized method and system of keeping track of the safety standard and implementing response for fault detection, health monitoring, and predictive maintenance.

### SUMMARY

Example embodiments consistent with the present disclosure provide a system and process for managing resources in a vehicle, the system may include a primary electronic control unit (ECU) comprising a virtual machine (VM) and a type one hypervisor; and a plurality of secondary ECUs communicatively coupled to the primary ECU, each of the plurality of secondary ECUs comprises a physical resource; wherein the type one hypervisor is configured to: receive, from at least one ECU of the plurality of secondary ECU's, sensor data associated with a physical resource of the at least one ECU, wherein the physical resource is associated with a tag stored in a safety standard compliant database; and detect, based on the sensor data, that a fault has occurred; and determine, based on detecting the fault has occurred and the tag, whether an intervention action should be executed by the vehicle.

According to embodiments, the type one hypervisor may be further configured to: generate a summary of the sensor data, as well as determine if a value of the sensor data exceeds a predetermined threshold value; and based on determining the value exceeds the predetermined threshold value, generate an alert in the summary of the sensor data. The type one hypervisor may also be configured to generate an alert based on executing an intervention action.

Detecting that a fault has occurred may be based on a machine learning model. The intervention action may correspond to the tag in the safety standard compliant database. The safety standard compliant database may be Automotive Safety Level Determination (ASLD) compliant.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like reference numerals denote like elements, and wherein:

FIG. 1 illustrates a block diagram of an example system configuration for managing shared resources according to one or more example embodiments;

FIG. 2 illustrates a block diagram of an example configuration of virtual and physical elements in the system, according to one or more example embodiments;

FIG. 3 illustrates an example tag and resource allocation, according to one or more example embodiments;

FIG. 4 illustrates a block diagram for fault detection and intervention using the tagging system, according to one or more example embodiments;

FIG. 5 illustrates an example method for fault detection and intervention, according to one or more example embodiments; and

FIG. 6 illustrates a diagram of an example components of a system that may be configured to implement one or more example embodiments.

### DETAILED DESCRIPTION

The following detailed description of exemplary embodiments refers to the accompanying drawings. The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “[A] and/or [B]”, “at least one of [A] and [B]” or “at least one of [A] or [B]” are to be understood as including only A, only B, or both A and B.

Expressions such as “at least one processor,” where configured to implement a plurality of operations, execute a plurality of instructions, etc., are to be understood as a single processor implementing the plurality of operations, etc., or each of plural processors implementing at least some (but not necessarily all) of the plurality of operations, etc.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Further, the described features, advantages, and characteristics of the present disclosure may be combined in any suitable manner in one or more example embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Furthermore, the term “vehicle” described herein refers to any suitable type of vehicle in which example embodiments of the present disclosure can be implemented. For instance, the “vehicle” may refer to a motorized vehicle such as a car, a truck, a bus, a motorcycle, or any other suitable type of automobile powered by an engine, motor, or other mechanical means. Alternatively or additionally, the “vehicle” described herein may refer to a bicycle, a skateboard, and any other suitable types of non-motorized vehicle, without departing from the scope of the present disclosure.

Example embodiments of the present disclosure provide systems, methods, devices, and the like, that provide centralized resource information management (e.g., storing, updating, utilizing, etc. of the resource information) in a vehicle. Specifically, example embodiments of the present disclosure utilize a type one hypervisor (implemented in a primary ECU) to centrally manage resource information of a plurality of secondary ECUs, and then appropriately allocate resources constituted by the plurality of secondary ECUs based thereon.

Example embodiments of the present disclosure provide systems, methods, devices, and the like, that provide centralized resource information management with a standard compliant lookup.

According to example embodiments, a system for centralized resource information management may be provided. The system may include: a primary electronic control unit (ECU) comprising a virtual machine (VM) and a type one hypervisor; and a plurality of secondary ECUs communicatively coupled to the primary ECU, each of the plurality of secondary ECUs comprises a physical resource; wherein the type one hypervisor is configured to: receive, from at least one ECU of the plurality of secondary ECU's, sensor data associated with a physical resource of the at least one ECU, wherein the physical resource is associated with a tag stored in a safety standard compliant database; and detect, based on the sensor data, that a fault has occurred; and determine, based on detecting the fault has occurred and the tag, whether an intervention action should be executed by the vehicle.

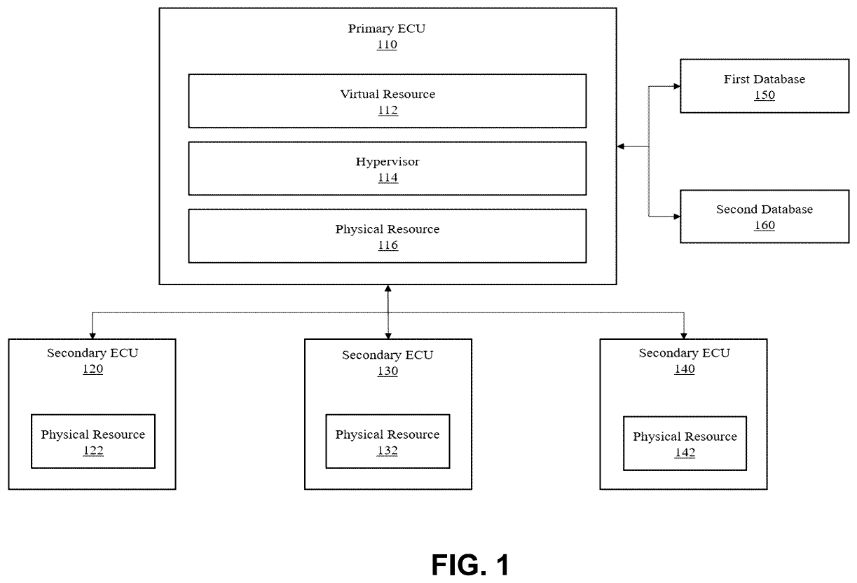

FIG. 1 illustrates a block diagram of an example system configuration for managing shared resources according to one or more example embodiments.

As shown in FIG. 1, the system configuration may include at least a primary electronic control unit (ECU) 110, a plurality of secondary ECUs 120,130,140, a first database 150, and a second database 160. It can be understood that the configuration illustrated in FIG. 1 is simplified for descriptive purpose, and is not intended to limit the scope of the present disclosure in any way. For example, the number of the secondary ECUs can be any number.

The primary ECU 110 may include a physical resource 118. The physical resource 118 may include resources provided by the hardware of the primary ECU 110 such as a processor (e.g., CPU, GPU, etc.), a memory (e.g., RAM, etc.), and the like.

The secondary ECU 120, the secondary ECU 130, and the secondary ECU 140 may include physical resource 122, physical resource 132, and physical resource 142, respectively. The physical resources 122,132,142 may include resources provided by the hardware of the corresponding secondary ECUs 120,130,140, in the similar manner as the physical resource 118. Further, the secondary ECUs 120,130,140 may be communicatively coupled to the primary ECU 110 in order to report and provide the physical resources 122,132,142 to the primary ECU 110.

Here, the primary ECU 110 and the secondary ECUs 120,130,140 may each include a system on chip (SoC). Such SoC may include at least one of a processor and a memory, corresponding to the physical resources 118, 122, 132, 142 of the primary ECU 110 and the secondary ECUs 120,130,140.

Further, the primary ECU 110 may also include a virtual machine 112, a virtual resource 114 and a hypervisor 116.

The hypervisor 116 may include a type one (Type-1) hypervisor, which may refer to a type of virtualization software that runs on the primary ECU 110 and directly access physical resources available to the primary ECU 110 to generate and manage virtual machines and virtual resources. In this regard, the hypervisor 116 may be configured to generate and manage the virtual machine 112 and the virtual resource 114 corresponding to the plurality of secondary ECUs 120,130,140 and the plurality of physical resources 122,132,142.

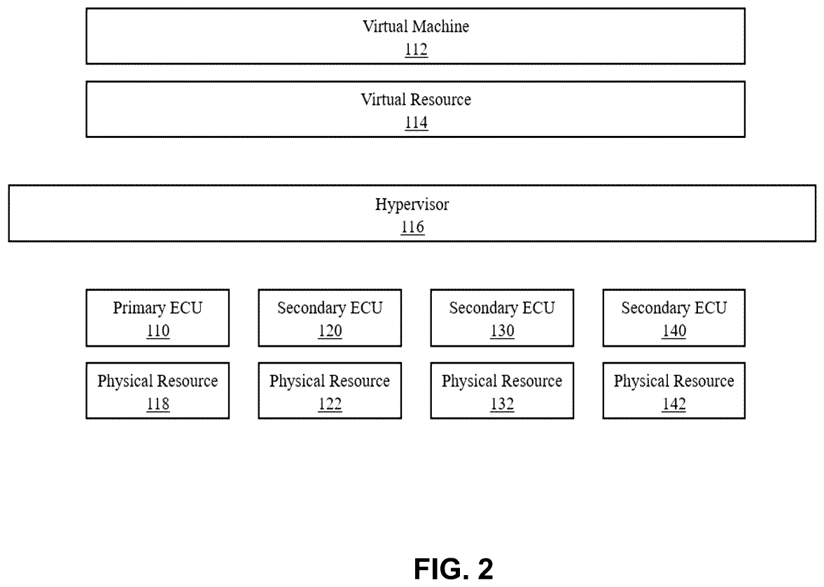

FIG. 2 illustrates a block diagram of an example configuration of virtual and physical elements in the system, according to one or more example embodiments.

As shown in FIG. 2, the virtual elements may include the virtual machine 112, the virtual resource 114, and the hypervisor 116, while the physical elements may include the primary ECU 110, the plurality of secondary ECUs 120,130,140, and the plurality physical resources 118,122,132,142.

The virtual machine 112 may be generated and managed by the hypervisor 116, and may be configured to perform operations and have functionalities corresponding to the operations and functionalities of the primary ECU 110 and the plurality of secondary ECUs 120,130,140. The virtual machine 112 may also represent a virtualization of a combination of the primary ECU 110 and the plurality of secondary ECUs 120,130,140 (i.e., ECUs connected to the primary ECU 110). For example, if the primary ECU 110 corresponds to an ADAS ECU, the secondary ECU 120 corresponds to the IVI ECU, the secondary ECU 130 corresponds to the PCM ECU, and the secondary ECU 140 corresponds to the GEM ECU, the virtual machine 112 may represent a virtualization of a combination of such ADAS ECU, IVI ECU, PCM ECU, and GEM ECU. Here, it is understood that the number of the virtual machine can be any number. For example, hypervisor 116 may generate and manage 4 virtual machines, where each of the virtual machines represents a virtualization of each of the ADAS ECU, IVI ECU, PCM ECU, and GEM ECU.

The virtual resource 114 may be generated and managed by the hypervisor 116, and may include resources corresponding to the plurality physical resources 118,122,132,142. In particular, since the secondary ECUs 120,130,140 report and provide the physical resources 122,132,142 to the primary ECU 110, the hypervisor 116 may directly access physical resource 118 of the primary ECU 110, as well as physical resources 122,132,142 of the secondary ECUs 120,130,140, in order to generate and manage the virtual resource 114. As such, the hypervisor 116 may operate as a single instance across multiple ECUs. The virtual resource 114 may also represent a virtualization of a combination of physical resource 118 and physical resources 122,132,142 (i.e., physical resources available to the primary ECU 110). For example, if the physical resource 118 include a 5 GB memory, physical resource 122 include a 2 GB memory, physical resource 132 include a 3 GB memory, and physical resource 142 include a 10 GB memory, the virtual resource 114 may represent a virtualization of such memories and may correspond to the combination of such memories (i.e., 20 GB).

The first database 150 may include a database storing information associated with the primary ECU 110, the secondary ECUs 120,130,140, and the physical resources associated with the primary ECU and the secondary ECU. Here, it is understood that the secondary ECUs 120,130,140 (which information is stored in the first database) refer to secondary ECUs that are currently connected and coupled to the primary ECU (e.g., the secondary ECUs currently installed in the vehicle which the primary ECU is installed). The information may include characteristic information of the primary ECU 110, the secondary ECUs 120,130,140, and the physical resources associated with the primary ECU and the secondary ECU. For example, the characteristic information may include the type of ECU (e.g., ADAS, IVI, etc.), the interfaces/ports which the primary ECU 110 and the secondary ECUs 120,130,140 are communicatively coupled, the type of the physical resources (processing, memory, etc.), virtual addresses associated with physical resources 122,132,142, power requirements, latency requirements, and the like. The information may also include state information of the primary ECU 110, the secondary ECUs 120,130,140, and the physical resources associated with the primary ECU and the secondary ECU. For example, the state information may include available, not available, in-use, inaccessible, and the like. Further, the characteristic information of the primary ECU 110, the secondary ECUs 120,130,140, and the physical resources associated with the primary ECU and the secondary ECU stored in the first database 150 may be obtained from the second database 160.

The second database 160 may include a database storing information associated with a plurality of ECUs. The information may be predefined and may include characteristic information of the plurality of ECUs. For example, the characteristic information may include various types of ECU (e.g., ADAS, IVI, etc.), interfaces/ports associated with the various types of ECU, physical resources (processing, memory, etc.) associated with the various types of ECU, power requirements, latency requirements, and the like. In this regard, the characteristic information associated with a plurality of ECUs may include the characteristic information associated with the primary ECU 110 and the secondary ECUs 120,130,140. For example, if the secondary ECU 120 corresponds to an IVI ECU, the hypervisor may be configured to obtain characteristic information of the secondary ECU 120 by obtaining characteristic information of an IVI ECU from the second database 160 (e.g., what kind of interfaces/ports are comprised in an IVI ECU, what kind of physical resources are comprised in an IVI ECU and how much, etc.) and store such information in the first database 150.

In this regard, the hypervisor 116 may be configured to allocate a portion of resource from the virtual resource 114 to the virtual machine 112 in order to perform a plurality of functions based on the information stored in the first database 150. The plurality of functions may correspond to the functions of the virtual machine 112, which in turn corresponds to the functions of the primary ECU 110 and the plurality of secondary ECUs 120,130,140.

In particular, as described above, the information stored in the first database 150 may include characteristic information and state information of the primary ECU 110, the secondary ECUs 120,130,140, and the physical resources associated with the primary ECU and the secondary ECU, where the hypervisor 116 may be configured to allocate a portion of resource from the virtual resource 114 to perform the plurality of functions based on such characteristic information and state information.

For example, in order to perform a function associated with driving assistance (i.e., functions of ADAS ECU, which is virtualized to the virtual machine 112) which requires low latency memory of at least 10 GB, the hypervisor 116 may identify, based on the characteristic information and state information stored in the first database 150, that the secondary ECU 140 has a low latency 10 GB memory (physical resource 142) and that such memory is available (not in-use). Accordingly, the hypervisor 116 may allocate a portion of resources (10 GB) from the virtual resource 114 (20 GB) which corresponds to the physical resource 142 of the secondary ECU 140 to perform the function (i.e., configure the secondary ECU 140 to utilize the physical resource 142 to perform the function).

It is understood that the present disclosure is not limited in how specifically the hypervisor determines a strategy for allocating the resources. According to example embodiments, the hypervisor 116 may be configured to communicate and interact with a real time operating system (RTOS) in order to allocate a portion of resource from the virtual resource 114 to perform the plurality of functions. The involvement of the RTOS ensures accurate timing of various processes at real time speed

Further, the hypervisor 116 may be configured to update the virtual resource 114 based on physical resources of all secondary ECUs currently coupled to the primary ECU 110.

In particular, the hypervisor 116 may be configured to update the virtual machine 112 and the virtual resource 114 to include a new secondary ECU and a physical resource of such new secondary ECU. For example, a new secondary ECU may be newly added and installed in the vehicle and may be newly connected and coupled to the primary ECU 110. In this regard, for example, the new secondary ECU may report its identify (e.g., via tags, ID, etc. using API within the SoC) to the hypervisor 116 during start up, where the hypervisor 116 may then obtain characteristic information of such new secondary ECU (as well as the physical resource of such new secondary ECU) from the second database 160, and store such information in the first database 150. Subsequently, the hypervisor 116 may be configured to update the virtual machine 112 to include the functionalities of the new secondary ECU, as well as to update the virtual resource 114 to include the physical resource of the new secondary ECU, such that the virtual resource 114 now represent a virtualization of a combination of physical resource 118, physical resources 122,132,142, and the physical resource of the new secondary ECU.

Similarly, the hypervisor 116 may be configured to update the virtual machine 112 and the virtual resource 114 to remove an existing secondary ECU and/or a physical resource of such existing secondary ECU. For example, the memory (physical resource) of the secondary ECU 120 may be faulty and is removed/uninstalled from the vehicle. In this regard, for example, the hypervisor 116 may determine that the virtual resource 114 should be updated to remove the physical resource 122 of the secondary ECU 120 (e.g., based on detecting a disconnection of the secondary ECU 120, based on identifying that the state of the memory of the secondary ECU 120 is not accessible, and the like). Subsequently, the hypervisor 116 may be configured to update the virtual resource 114 to remove the physical resource 122 of the secondary ECU 120, such that the virtual resource 114 now represent a virtualization of a combination of physical resource 118, and physical resources 132,142.

According to example embodiments, the system configuration may also include a centralized power source that may be configured to provide power to the primary ECU 110 and the secondary ECUs 120,130,140 to perform the function of the vehicle. For example, once the hypervisor 116 allocates a portion of resources (10 GB) from the virtual resource 114 (20 GB) which corresponds to the physical resource 142 of the secondary ECU 140 to perform the function, the secondary ECU 140 may accordingly draw corresponding power from the power source.

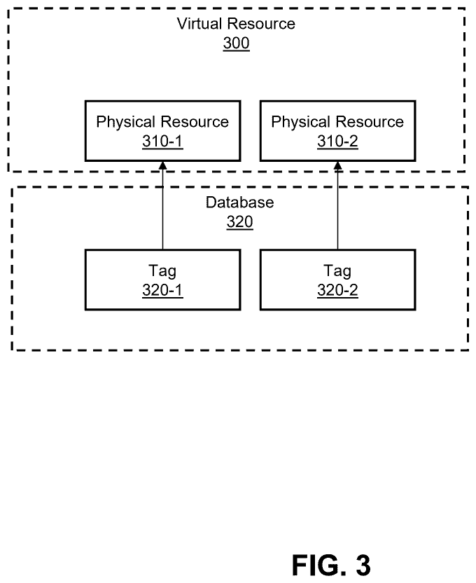

FIG. 3 illustrates an example tag and resource allocation, according to one or more example embodiments.

The type one hypervisor of the primary ECU (as described with reference to FIGS. 1 and 2 above) may be configured to perform virtualization of a combination of physical resources of the plurality of secondary ECUs, thereby generating a virtual resource that may be allocated and consumed by the VM. The operations associated with the plurality of secondary ECUs may be implemented in the VM. Accordingly, the type one hypervisor of the primary ECU may manage the operations in the VM and allocate resources to the operations when required.

Referring to FIG. 3, physical resource 310-1, 310-2 may be provided, and have corresponding tags 320-1 and 320-2 respectively. Physical resource 310-1, 310-2 may be allocated into virtual resource 300. Tags 320-1 and 320-2 may be stored in database 320.

Type one hypervisor of the primary ECU may be configured to receive, from a portion of the plurality of secondary ECU's, tags 320-1 and 320-2 (and associated qualifiers), which describe physical resource 310-1 and 310-2. The tags and qualifiers may define the resource information of the secondary ECUs, such as the state, capacity, availability, etc., of the associated physical resources. Specifically, the tags may serve as identifiers or classifications for resource types, while the qualifiers may define the attributes or conditions (e.g., priorities, limits, etc.) for the tagged resources. For instance, a computing/processing unit like a CPU may include a “real_time” tag that classifies the CPU as dedicated to real-time operations, a “general” tag that classifies the CPU as dedicated to general/non-real-time operations, and the like. Further, the CPU may include qualifiers such as “maximum utilization” that defines the maximum usage of the CPU (e.g., “max_utiliization =40%”, etc.), “guaranteed allocation” that defines the minimum CPU power that can be allocated to a specific operation (e.g., “guaranteed allocation=800 MHz”, etc.).

According to example embodiments, upon implementation of a secondary ECU, the secondary ECU may provide the tags and qualifiers to the type one hypervisor of the primary ECU. For instance, on startup, the SoCs of the secondary ECUs may communicate the tags and qualifiers to the type one hypervisor of the primary ECU. In some example embodiments, the secondary ECUs may periodically (or continuously) provide the tags and qualifiers to the type one hypervisor, thereby updating the latest information of the associated physical resource to the type one hypervisor. The type one hypervisor may store the tags and qualifiers in a database 320 (that implements the global shared memory), and such that the tags and qualifiers may be utilized for resource management (e.g., resource allocation, reallocation, etc.) when required.

According to example embodiments, the type one hypervisor of the primary ECU may be configured to receive, from the VM, a request for resources to execute an operation. For instance, when an application implemented in the VM requires resources to execute an operation, the VM may generate and send a request to the type one hypervisor, through the RTOS.

Upon receiving the request, the type one hypervisor may be configured to determine, based on the tags and qualifiers, a portion of the virtual resource 300 (which is a virtualization of the combination of the physical resources 310-1 and 310-2 of the plurality of secondary ECUs) that can be allocated to the VM. For instance, the type one hypervisor may determine, based on the tags and qualifiers, at least one of the secondary ECUs has sufficient physical resources to execute the operation, determine a portion of the virtual resource that is associated with the determined at least one secondary ECU, and then allocate the portion of the virtual resource to the VM (e.g., as virtual resource 300).

Upon allocating the virtual resource 300, the VM may utilize the associated physical resource of the associated secondary ECU to execute the operation. In this regard, once the associated physical resource is occupied, the associated secondary ECU may send, to the type one hypervisor, an updated tag that defines/indicates that the physical resource is unavailable. On the other hand, if the secondary ECU determines that the associated physical resource is still available after the resource allocation (e.g., the physical resource of the secondary ECU is sufficient for executing more than one operation at one time, etc.), the secondary ECU may send, to the type one hypervisor, an updated tag that defines/indicates the percentage of occupied/available physical resources. Accordingly, the type one hypervisor may store the updated tag to the database (e.g., replace the existing tag, etc.).

When the operation is completed (i.e., the VM is no longer utilize or require the allocated resources), the associated secondary ECU may send, to the type one hypervisor, an updated tag that defines/indicates that the associated physical resource is available to be allocated again. Accordingly, the type one hypervisor may store the updated tag to the database.

When there is a failure (e.g., hardware failure, etc.) in the secondary ECU, the secondary ECU may stop sending the tags or qualifiers to the type one hypervisor. In this regard, if the type one hypervisor does not receive any tags or qualifiers from a secondary ECU, the type one hypervisor may determine that the physical resource of the secondary ECU is no longer available to be allocated (i.e., the associated physical resource is no longer available as a resource from the point of view of the RTOS).

According to example embodiments, In case of the secondary ECU associated with the allocated resource experiences a failure (e.g., a hardware dropout, etc.) when the VM is executing the operation, the type one hypervisor may reallocate to the VM other resources (if the database contains appropriate tags and qualifiers that indicate that suitable resources are available to be allocated to the VM).

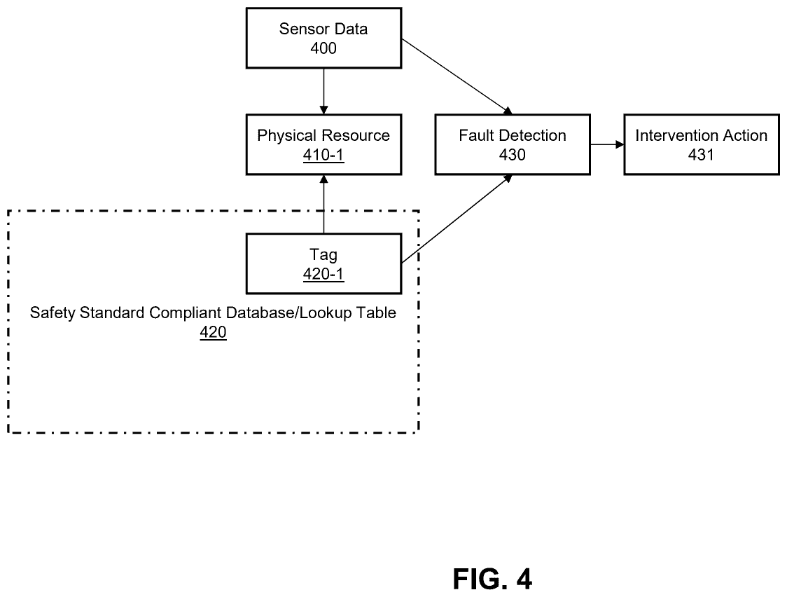

FIG. 4 illustrates a block diagram for fault detection and intervention using the tagging system, according to one or more example embodiments.

According to example embodiments, a safety standard compliant database 420 (which may be ASLD as described above or ASIL) may comprise a lookup table including tags (for example, tag 420-1) associating a particular physical resource (for example, physical resource 410-1) associated with one of the secondary ECU's with a safety standard related action. For example, the tag 420-1 may be an identifier number/string. The tag 420-1 may then be associated with a particular intervention action 431, which may be executed upon detecting a fault by fault detection 430. For example, this may include some form of predictive maintenance (restarting the processor, performing synchronization, etc.), or if the safety critical level is severe enough, it could force the vehicle to stop until the issue is resolved. If the safety critical level is not high, then the system may for example chose to reallocate resources to other virtual resources associated with a different physical resource.

The system may also choose to allocate more resources pre-emptively to tags associated with a higher safety critical level, based on checking the safety critical level in the lookup table in 420. This is in view that such processes may require more checking or processing power to ensure safe operation of the vehicle. Conversely, less resources may be pre-emptively allocated to lower safety critical levels. In some embodiments, the dynamic resource allocation may be performed by having a maximum and minimum memory/CPU processing value per safety critical level, and adjusting the values using the hypervisor in realtime (for example, based on active load data).

Faults may be detected by the hypervisor based on algorithms implemented by the hypervisor, using logic in fault detection 430. For example, the faults may be detected based on sensor data 400 received from each ECU exceeding a value calculated by said algorithm. The sensor data 400 may be provided in realtime. According to some embodiments, the algorithms may be based on or implemented using machine learning models. It is contemplated that the machine learning model could be trained using historical fault data and sensor data 400, nevertheless the specific implementation thereof may vary. Based on detecting the fault for a given physical resource 410-1of an ECU, the intervention action 431 as described above may be executed for the ECU by using the tag in the lookup table to check the appropriate action.

According to embodiments, system/vehicle health monitoring can be implemented by the hypervisor using the received sensor data 400. For example, the system may aggregate all received sensor data from the ECU, and generate a summary/dashboard interface for an operator to view. Alerts may be generated based on analyzing the aggregated data. For example, if a value of the sensor data 400 exceeds a predetermined threshold value, an alert could be generated. Alternatively, machine learning models may also be implemented to alert the operator based on abnormalities with respect to historic aggregated data. Although the above describes the health monitoring and interface in a visible form, it may also be implemented solely in code/database for the system to quickly be able to refer to, and quickly resolve any outstanding issues.

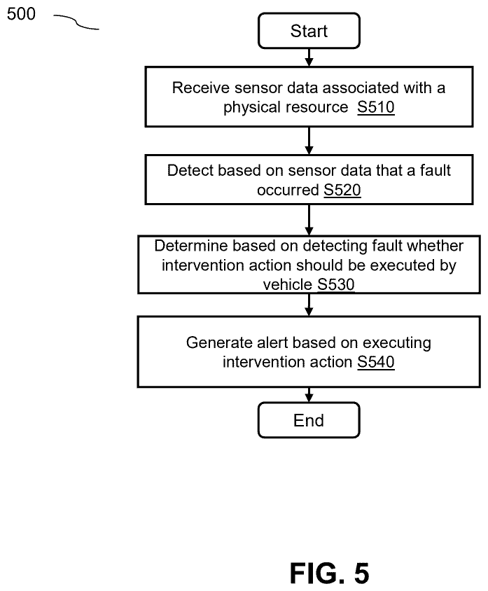

FIG. 5 illustrates an example method 500 for fault detection and intervention, according to one or more example embodiments.

At operation S510, sensor data associated with a physical resource may be received from at least one ECU of a plurality of secondary ECU's. The physical resource may be associated with a tags stored in a safety standard compliant database (such as ASLD). The system may generate a summary of the sensor data (aggregated data).

At operation S520, faults may be detected based on sensor data. This may be performed based on determining if a value of the sensor data exceeds a predetermined threshold value, and generating an alert in the summary of the sensor data accordingly. Furthermore, detection may be performed using AI/machine learning-based techniques, depending on the specific implementation thereof.

At operation S530, it may be determined as to whether an intervention action should be executed by the vehicle, based on the type of fault detected in operation S520. The intervention action may be found based on referring to the tag in the safety standard compliant database.

At operation S540, an alert may be generated based on executing the intervention action in operation S530. For example, if the intervention action includes shutting down the engine, then the alert may indicate that engine shutoff has occurred.

The present disclosure provides a process that enables shared resources across various ECUs within the vehicle, which allows for scalability of hardware in the vehicle as well as provides redundancy in case of hardware failures. In particular, the shared resources allows for a new hardware (e.g., new ECU) to be easily added to provide additional resources to the vehicle. The shared resources also allows for allocation of resources away from a faulty hardware to a working hardware, without substantially affecting the performance and safety of the vehicle, and thereby allowing for the faulty hardware to be easily removed.

Example embodiments of the present disclosure can be understood based on the above, to allow for improved detection of abnormalities, predictive maintenance capabilities, and rapid identification and resolution of issues, ensuring consistent safety levels.

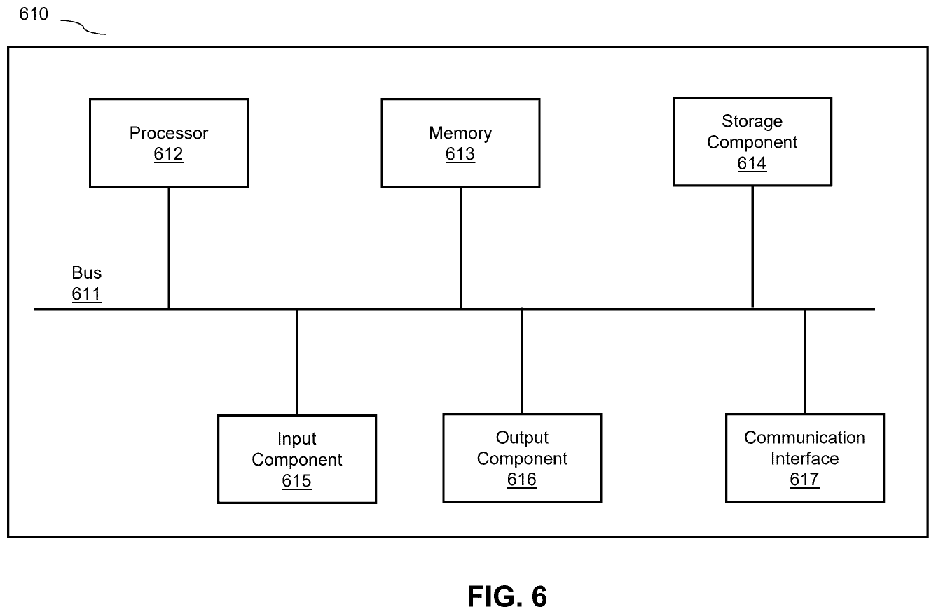

FIG. 6 illustrates a diagram of example components of a system, according to one or more example embodiments. As illustrated in FIG. 6, the system 610 may include at least one bus 611, at least one processor 612, at least one memory 613, at least one storage component 614, at least one input component 615, at least one output component 616, and at least one communication interface 617.

It is contemplated that the system 610 may include more or less components than illustrated in FIG. 6, without departing from the scope of the present disclosure. For instance, in some embodiments, the system 610 may include a plurality of storage components 614, the input component 615 and the output component 616 may be implemented as a transceiver component, the memory 613 and storage component 614 may be implemented as a memory storage, and the like.

The bus 611 may be configured to facilitate or enable communications among the components of the system 610. Specifically, the bus 611 may communicatively couple the components to each other and provide a means for data transfer and flow of control signals between the components. The bus 611 may include one or more of: an internal bus, an address bus, a data bus, a control bus, a controller area network (CAN) bus, an Ethernet bus, a peripheral component interconnect express (PCIe) bus, and any other suitable type of bus that can be implemented in the system 610 to enable communication and coordination between the components within the system 610 in real-time (or near real-time).

The processor 612 may be implemented in hardware, firmware, or a combination of hardware and software, and may be configured to handle real-time (or near real-time) data processing and control of the control system 610. The processor 612 may include one or more of: a central processing unit (CPU), a graphics processing unit (GPU), a neural processing unit (NPU), a tensor processing unit (TPU), an accelerated processing unit (APU), a microprocessor, a microcontroller, a digital signal processor (DSP), a field-programmable gate array (FPGA), an application-specific integrated circuit (ASIC), and/or another type of processing or computing component that can be implemented in the system 610. In some implementations, the processor 612 may be capable of being programmed to perform one or more operations described herein. Further, the processor 612 may include a plurality of processing units, each of which is dedicated to performing a specific operation.

The memory 613 may include one or more mediums for storing temporary data, runtime variables, program instructions, and buffers required for the operations of the control system 610. The memory 613 may include one or more of: a flash memory, a read-only memory (ROM), a random-access memory (RAM), a dynamic or static storage device (e.g., a flash memory, a magnetic memory, and/or an optical memory), any other suitable type of memory that can be implemented in the system 610 to store information and/or instructions for use by the processor 612.

The storage component 614 may be configured to store non-volatile data, such as firmware, configuration settings, calibration data, information, and/or software related to the operation and use of the system 610. For example, the storage component 614 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to embodiments, the storage component 614 may be configured to store computer-readable or computer-executable instructions for implementing one or more operations of the system 610. The storage component 614 may provide the stored information to the memory 613 for the execution of the processor 612.

The input component 615 may include one or more input components that permit the system 610 to receive information, such as via user input (e.g., a touch screen display, a keyboard, a keypad, a mouse, a button, a switch, and/or a microphone). The output component 616 may include one or more output components that provide output information from the system 610 (e.g., a display, a speaker, a navigation device, one or more light-emitting diodes (LEDs), etc.) According to embodiments, the input component 615 and/or the output component 616 may be optional and may be excluded from the system 610.

The at least one communication interface 617 may include a transceiver-like component (e.g., a transceiver and/or a separate receiver and transmitter) that enables the system 610 to communicate with other components (e.g., ECUs, user devices, etc.), such as via a wired connection, a wireless connection, or a combination of wired and wireless connections. For example, communication interface 617 may include a controller area network (CAN) bus interface, an Ethernet interface, an optical interface, a coaxial interface, an infrared interface, a radio frequency (RF) interface, a universal serial bus (USB) interface, a Wi-Fi interface, a cellular network interface, or the like.

According to one or more embodiments, the communication interface 617 may include at least one input/output (I/O) interface, at least one network interface, at least one storage interface, or the like, that enable the components 612-616 to communicate with other components. Further, the communication interface 617 may include one or more application programming interfaces (APIs) that allow the system 610 (or one or more components included therein) to communicate with one or more software applications (e.g., software application deployed in the ECUs, etc.)

Computer-executable instructions (e.g., software instructions, etc.) may be read into memory 613 and/or storage component 614 from another computer-readable medium or from another device (e.g., a remote server, an external storage, etc.) via, for example, the communication interface 617. When executed, the computer-executable instructions stored in memory 613 and/or storage component 614 may cause the processor 612 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

Based on the above, it can be understood that example embodiments of the present disclosure allow for decision making to be based on relative position data and on a per lane sequence basis, such that the prediction can be more accurate and more robust, since it is not based on state definitions, position data can be provided externally aside from a data collection vehicle, and each possibility on a per lane sequence basis can be considered. Further, cost is reduced since humans do not need to label the data manually, as would be the case in the related art.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of example embodiments of the present disclosure, as well as the associated technical advantages and significances, are provided in the following.

It is understood that the specific order or hierarchy of blocks in the processes/ flowcharts disclosed herein is an illustration of example approaches. Based upon design preferences, it is understood that the specific order or hierarchy of blocks in the processes/ flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer-readable medium at any possible technical detail level of integration. Further, as described hereinabove, one or more of the above components described above may be implemented as instructions stored on a computer readable medium and executable by at least one processor (and/or may include at least one processor). The computer-readable medium may include a computer-readable non-transitory storage medium (or media) having computer-readable program instructions thereon for causing a processor (or processors) to carry out operations.

The computer readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming languages such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a SoC, a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or another device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A system for managing resources in a vehicle, the system comprising:
a primary electronic control unit (ECU) comprising a virtual machine (VM) and a type one hypervisor; and
a plurality of secondary ECUs communicatively coupled to the primary ECU, each of the plurality of secondary ECUs comprises a physical resource;
wherein the type one hypervisor is configured to:
receive, from at least one ECU of the plurality of secondary ECU's, sensor data associated with a physical resource of the at least one ECU, wherein the physical resource is associated with a tag stored in a safety standard compliant database; and
detect, based on the sensor data, that a fault has occurred; and
determine, based on detecting the fault has occurred and the tag, whether an intervention action should be executed by the vehicle.

2. The system according to claim 1, wherein the type one hypervisor is further configured to:
generate a summary of the sensor data.

3. The system according to claim 2, wherein the type one hypervisor is further configured to:
determine if a value of the sensor data exceeds a predetermined threshold value; and
based on determining the value exceeds the predetermined threshold value, generate an alert in the summary of the sensor data.

4. The system according to claim 1, wherein detecting that a fault has occurred is based on a machine learning model.

5. The system according to claim 1, wherein the intervention action corresponds to the tag in the safety standard compliant database.

6. The system according to claim 1, wherein the safety standard compliant database is Automotive Safety Level Determination (ASLD) compliant.

7. The system according to claim 1, wherein the type one hypervisor is further configured to:
generate an alert based on executing the intervention action.

8. A method for managing resources in a vehicle comprising:
a primary electronic control unit (ECU) comprising a virtual machine (VM) and a type one hypervisor; and
a plurality of secondary ECUs communicatively coupled to the primary ECU, each of the plurality of secondary ECUs comprises a physical resource;
wherein the method comprises:
receiving, by the type one hypervisor, from at least one ECU of the plurality of secondary ECU's, sensor data associated with a physical resource of the at least one ECU, wherein the physical resource is associated with a tag stored in a safety standard compliant database; and
detecting, by the type one hypervisor based on the sensor data, that a fault has occurred; and
determining, by the type one hypervisor based on detecting the fault has occurred and the tag, whether an intervention action should be executed by the vehicle.

9. The method as claimed in claim 8, further comprising:
generating, by the type one hypervisor, a summary of the sensor data.

10. The method as claimed in claim 9, further comprising:
determining, by the type one hypervisor, if a value of the sensor data exceeds a predetermined threshold value; and
based on determining the value exceeds the predetermined threshold value, generating, by the type one hypervisor, an alert in the summary of the sensor data.

11. The method as claimed in claim 8, wherein detecting that a fault has occurred is based on a machine learning model.

12. The method as claimed in claim 8, wherein the intervention action corresponds to the tag in the safety standard compliant database.

13. The method as claimed in claim 8, wherein the safety standard compliant database is Automotive Safety Level Determination (ASLD) compliant.

14. The method as claimed in claim 8, further comprising:
generating, by the type one hypervisor, an alert based on executing the intervention action.

15. A non-transitory computer-readable recording medium having recorded thereon instructions to perform a method for managing resources in a vehicle comprising:
a primary electronic control unit (ECU) comprising a virtual machine (VM) and a type one hypervisor; and
a plurality of secondary ECUs communicatively coupled to the primary ECU, each of the plurality of secondary ECUs comprises a physical resource;
wherein the method comprises:
receiving, by the type one hypervisor, from at least one ECU of the plurality of secondary ECU's, sensor data associated with a physical resource of the at least one ECU, wherein the physical resource is associated with a tag stored in a safety standard compliant database; and
detecting, by the type one hypervisor based on the sensor data, that a fault has occurred; and
determining, by the type one hypervisor based on detecting the fault has occurred and the tag, whether an intervention action should be executed by the vehicle.

16. The non-transitory computer-readable recording medium as claimed in claim 15, the method further comprising:
generating, by the type one hypervisor, a summary of the sensor data.

17. The non-transitory computer-readable recording medium as claimed in claim 16, the method further comprising:
determining, by the type one hypervisor, if a value of the sensor data exceeds a predetermined threshold value; and
based on determining the value exceeds the predetermined threshold value, generating, by the type one hypervisor, an alert in the summary of the sensor data.

18. The non-transitory computer-readable recording medium as claimed in claim 15, wherein detecting that a fault has occurred is based on a machine learning model.

19. The non-transitory computer-readable recording medium as claimed in claim 15, wherein the intervention action corresponds to the tag in the safety standard compliant database.

20. The non-transitory computer-readable recording medium as claimed in claim 15, the method further comprising:
generating, by the type one hypervisor, an alert based on executing the intervention action.
